(19) United States
(12) Patent Application Publication
(10) Pub. No.: US 2019/0217507 A1
(43) Pub. Date: Jul. 18, 2019

(54) THREE-DIMENSIONAL PRINTING SYSTEM

(71) Applicants: XYZPRINTING, INC., NEW TAIPEI CITY (TW); KINPO ELECTRONICS, INC., NEW TAIPEI CITY (TW)

(72) Inventors: Yi-Min CHIU, NEW TAIPEI CITY (TW); Yang-Teh LEE, NEW TAIPEI CITY (TW)

(21) Appl. No.: 15/922,434

(22) Filed: Mar. 15, 2018

(30) Foreign Application Priority Data
Jan. 17, 2018 (CN) 201810044298.4

(51) Int. Cl. B29C 33/44; B29C 64/153; B22F 3/105; B29C 64/379; B29C 64/245; B65G 47/34

(52) U.S. Cl. CPC B29C 33/442; B29C 64/153; B22F 3/1055; B33Y 40/00; B29C 64/245; B65G 47/34; B29C 64/379

(57) ABSTRACT

A three-dimensional printing system for printing out an object includes a support plate, a delivery module, one or multiple printing devices, and an object detaching member. The delivery module includes a belt covering the support plate. The belt includes a printing area above the support plate and a separation section of the support plate. The printing device is arranged corresponding to the support plate. The object is formed layer by layer in the printing area via the printing device and is moved with the belt. The object detaching member is arranged under the belt and between the support plate and the separation section. The object detaching member includes an abutment portion abutted against the belt. The abutment portion is at a position higher than the separation section to form a height level difference.

### BACKGROUND OF THE INVENTION

### 1. Technical Field

The technical field relates to a printing platform structure and, in particular, to a three-dimensional printing system.

### 2. Description of Related Art

Three-dimensional (3D) printing is one of quick formation techniques. As a movable platform moves a work carrier, metal powders or plastic powders are deposited layer by layer and fused together to build up a 3D object by additive manufacturing techniques. Toy parts, mechanical parts or artificial human bones can be made by 3D printing, so 3D printing is growing rapidly in popularity with the consuming public.

However, the 3D object is formed through additive manufacturing techniques, so the object printed out is adhered to the work carrier. Then, a shovel is manually operated to take the object from the work carrier. As a result, if without manual labor to take down objects, mass production cannot be accomplished. Therefore, industries endeavor to create a solution to automatically print out a 3D object without the need of manually taking down the printed objects by a shovel.

In view of this, the inventor studied various technologies and created an effective solution in the present disclosure.

### SUMMARY OF THE INVENTION

The present disclosure provides a three-dimensional printing system. With a height level difference, a belt is inclined after an abutment portion. This configuration causes an object to be gradually detached from the belt. Accordingly, the need for manually operating a shovel to take down the objects is eliminated, and automatic three-dimensional printing production is achieved.

In one embodiment, a three-dimensional printing system is provided for printing out an object. The three-dimensional printing system includes: a support plate; a delivery module including a belt covering the support plate, the belt including a printing area above the support plate and including a separation section at one side of the support plate; at least one printing device disposed corresponding to the support plate, the object being formed layer by layer in the printing area via the printing device and being moved with the belt; and an object detaching member disposed under the belt and between the support plate and the separation section, the object detaching member including an abutment portion abutted against the belt, the abutment portion being at a position higher than a position of the separation section to form a height level difference between the abutment portion and the separation section, so that the object is detached from the belt when the object is moved to the separation section.

After the object is completely printed out in the printing area, the object adhered to the belt is moved by the belt to the inclined section. The belt is horizontal before the abutment portion, and is inclined after the abutment portion due to the height level difference. This configuration enables the object to be gradually detached from the belt, so that the object is separated from the belt when the object is moved to the separation section. As a result, the object can be successfully collected by a material collecting track to achieve automatic production.

According to a length of the printing area of the delivery module, one or multiple printing devices can be arranged. Therefore, the multiple printing devices can produce objects at the same time. The multiple objects printed out are then collected sequentially, thus achieving mass production and saving production time.

### BRIEF DESCRIPTION OF THE DRAWINGS

The disclosure will become more fully understood from the detailed description and the drawings given herein below for illustration only, and thus does not limit the disclosure, wherein:

FIG. 1 is a perspective assembled view illustrating a three-dimensional printing system according to the first embodiment of the present disclosure;

FIG. 2 is a cross-sectional view illustrating the three-dimensional printing system according to the first embodiment of the present disclosure;

FIG. 3 is a partial enlarged view illustrating the three-dimensional printing system according to the first embodiment of the present disclosure;

FIG. 4 is another partial enlarged view illustrating the three-dimensional printing system according to the first embodiment of the present disclosure;

FIG. 5 is a first in-use view illustrating the three-dimensional printing system according to the first embodiment of the present disclosure;

FIG. 6 is a second in-use view illustrating the three-dimensional printing system according to the first embodiment of the present disclosure;

FIG. 7 is a third in-use view illustrating the three-dimensional printing system according to the first embodiment of the present disclosure;

FIG. 8 is a schematic in-use view illustrating the three-dimensional printing system according to the second embodiment of the present disclosure;

FIG. 9 is a partial enlarged view illustrating the three-dimensional printing system according to the second embodiment of the present disclosure; and

FIG. 10 is a cross-sectional view illustrating the three-dimensional printing system according to the third embodiment of the present disclosure.

### DETAILED DESCRIPTION OF THE INVENTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

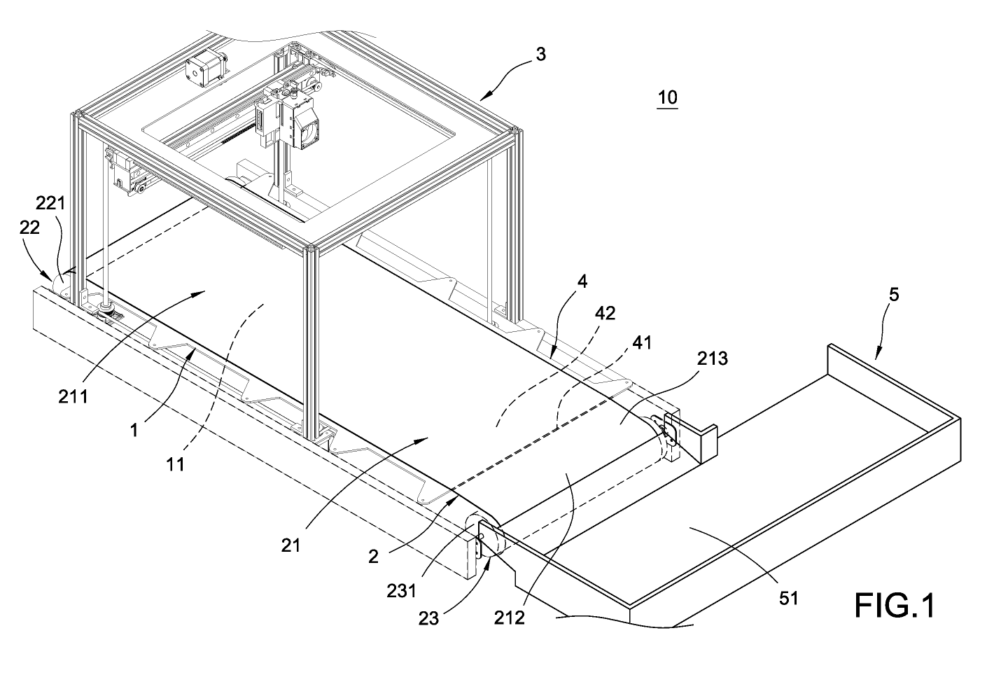

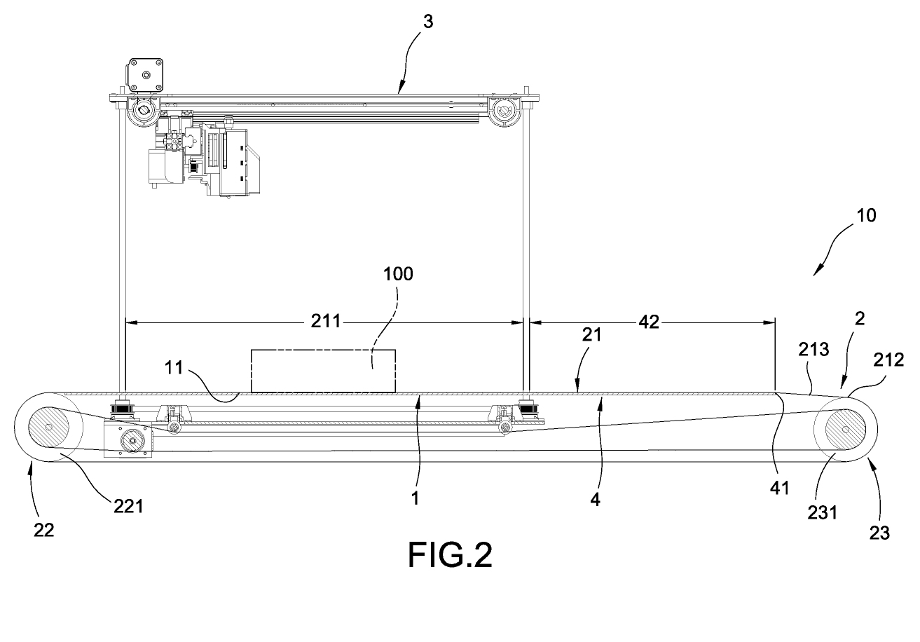

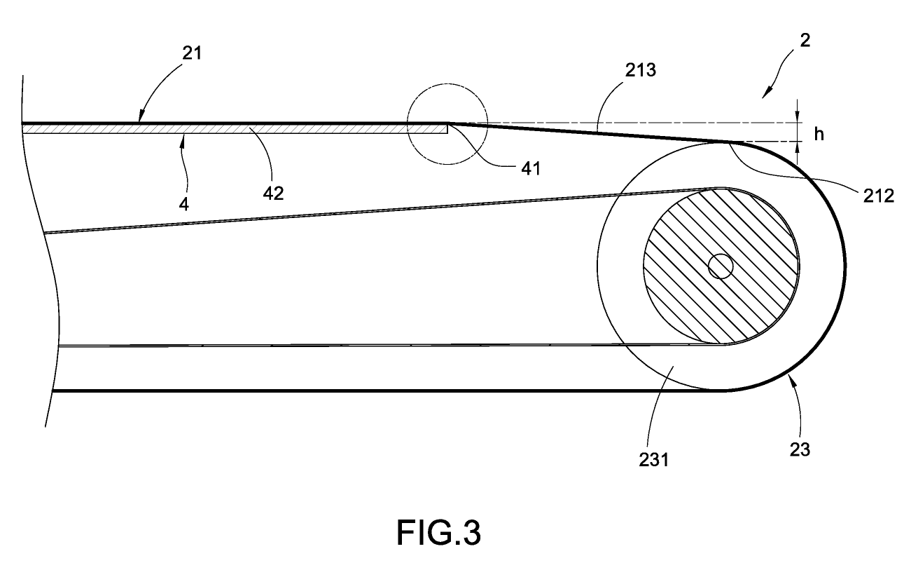

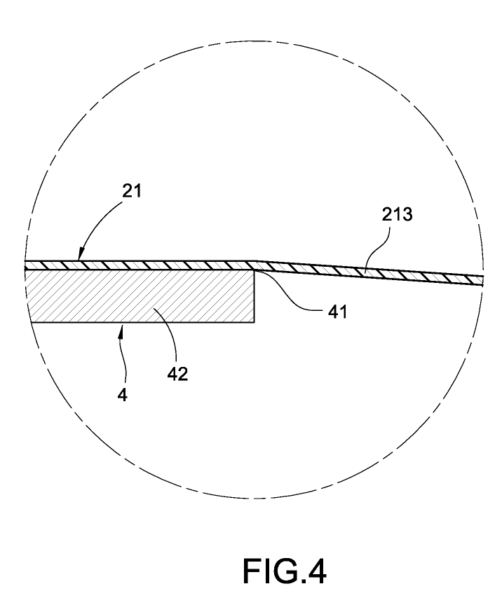

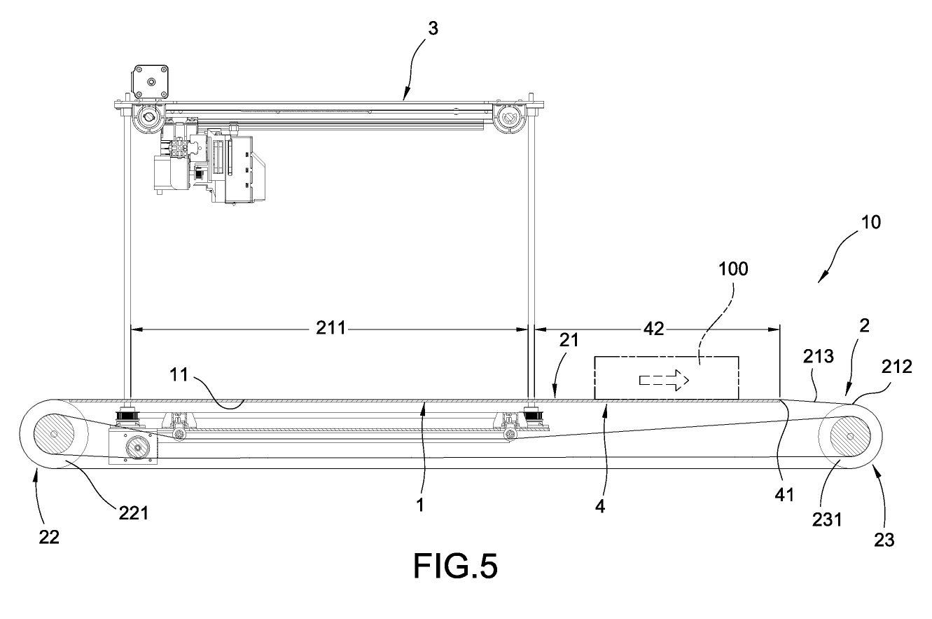

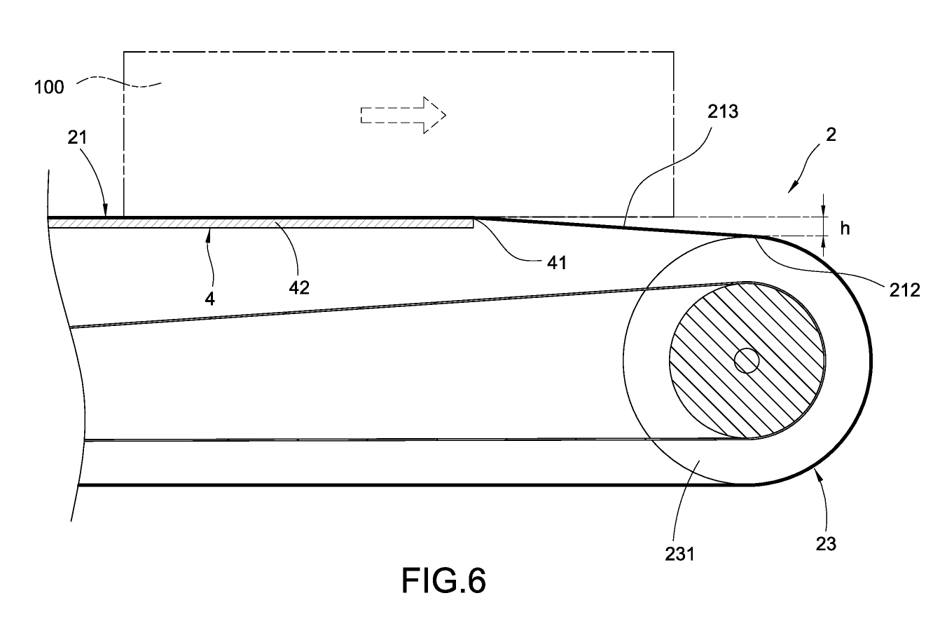

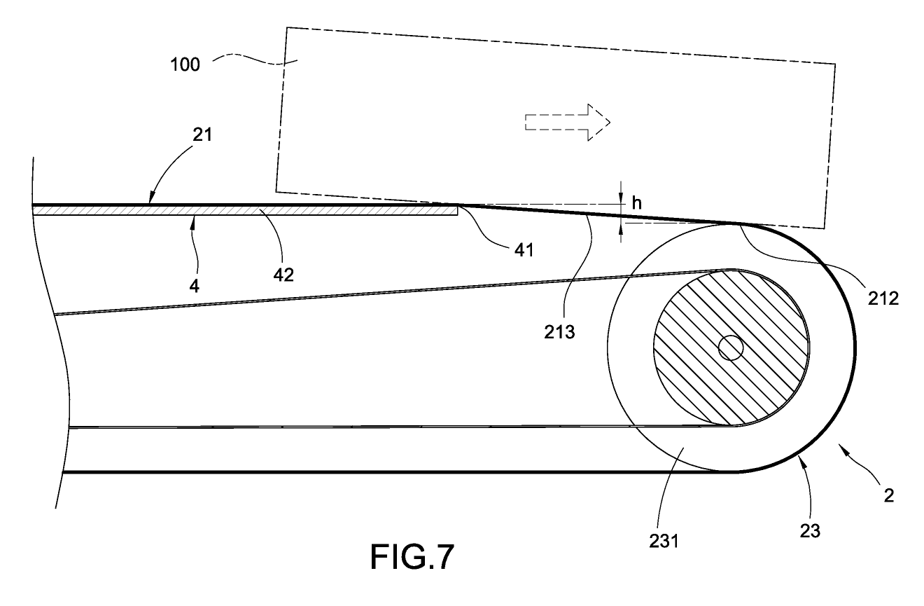

Referring to FIGS. 1 to 7, the present disclosure provides a three-dimensional printing system used for printing out an object 100. The three-dimensional printing system 10 includes a support plate 1, a support plate 1, a delivery module 2, one or multiple printing devices 3, and an object detaching member 4.

As shown in FIGS. 1 to 7, the support plate 1 is a hard flat plate made of metal, plastic, a ceramic material, or other suitable material. The support plate 1 has an upper surface 11.

As shown in FIGS. 1 to 7, the delivery module 2 includes a belt 21 covering the support plate 1. The upper surface 11 of the support plate 1 is in contact with the belt 21. The belt 21 includes a printing area 211 above the support plate 1 and includes a separation section 212 at one side of the support plate 1.

In detail, the delivery module 2 further includes a first roller 22 and a second roller 23, the first roller 22 and the second roller 23 are disposed at two sides of the support plate 1 to drive the belt 21 to move with respect to the support plate 1, and the separation section 212 is an area of the belt 21 in contact with the second roller 23. The first roller 22 is a drive wheel 221 actively driving the belt 21, and the second roller 23 is an idler 231 passively driving the belt 21; however, the present disclosure is not limited in this regard.

As shown in FIGS. 1, 2 and 5, the printing device 3 is disposed corresponding to the support plate 1, the object 100 is formed layer by layer in the printing area 211 via the printing device 3 and is moved away by the belt 21 after the object 100 is completely printed out.

As shown in FIGS. 1 to 7, the object detaching member 4 is disposed under the belt 21 and between the support plate 1 and the separation section 212. The object detaching member 4 includes an abutment portion 41 abutted against the belt 21, and the abutment portion 41 is at a position higher than a position of the separation section 212 to form a height level difference h therebetween, so that the belt 21 includes an inclined section 213 between the abutment portion 41 and the separation section 212, and a height level of the inclined section 213 gradually decreases in a direction away from the abutment portion 41, and thereby the object 100 is detached from the belt 21 when the object 100 is moved to the separation section 212.

Furthermore, the object detaching member 4 is an extending plate 4 extended from one side of the support plate 1, and the abutment portion 41 is formed at one end of the extending plate 42 at one side adjacent to the separation section 212. The upper surface 11 and the abutment portion 41 are substantially on the same horizontal plane.

As shown in FIG. 1, the three-dimensional printing system 10 further includes a material collecting track 5, the material collecting track 5 is disposed corresponding to the separation section 212, and the material collecting track 5 includes an inclined surface 51 whose height level decreases in a direction away from the separation section 212. Therefore, after the object 100 is detached from the belt 21, the object 100 is collected in the material collecting track 5 via the inclined surface 51, thus achieving automatic production.

Please refer to FIG. 1 and FIGS. 5 to 7 for in-use views illustrating the three-dimensional printing system 10. After the object 100 is completely printed out in the printing area 211, the object 100 adhered to the belt 21 is moved with the belt 21 to the inclined section 213. The belt 21 is horizontal before the abutment portion 41, and is inclined after the abutment portion 41 due to the height level difference h. This enables the object 100 to be gradually detached from the belt 21, so that the object 100 is separated from the belt 21 when the object 100 is moved to the separation section 212. As a result, the object 100 can be successfully collected by the material collecting track 5 to achieve automatic production. Accordingly, the need for manually operating a shovel to take down the objects is eliminated, and automatic three-dimensional printing production is achieved.

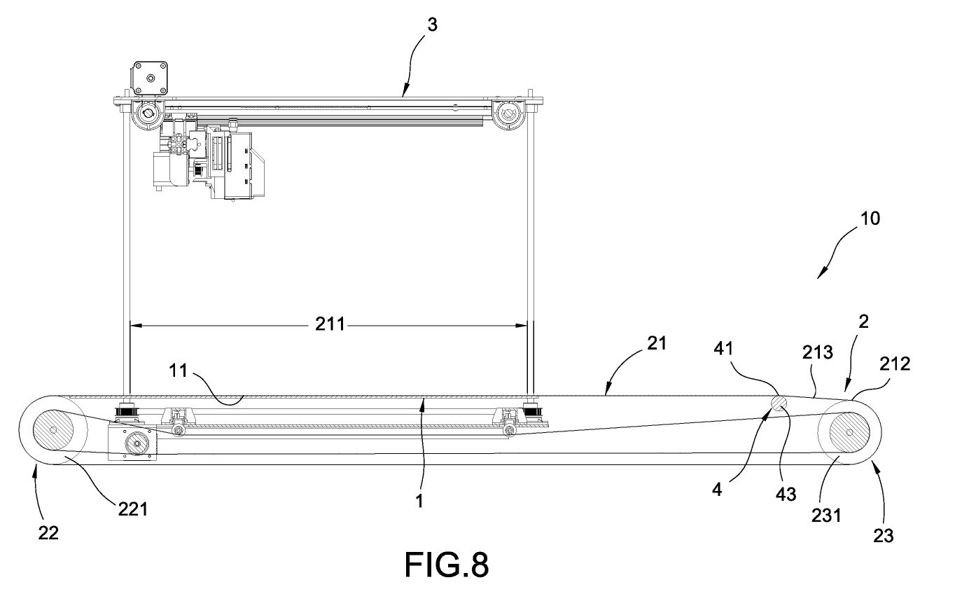

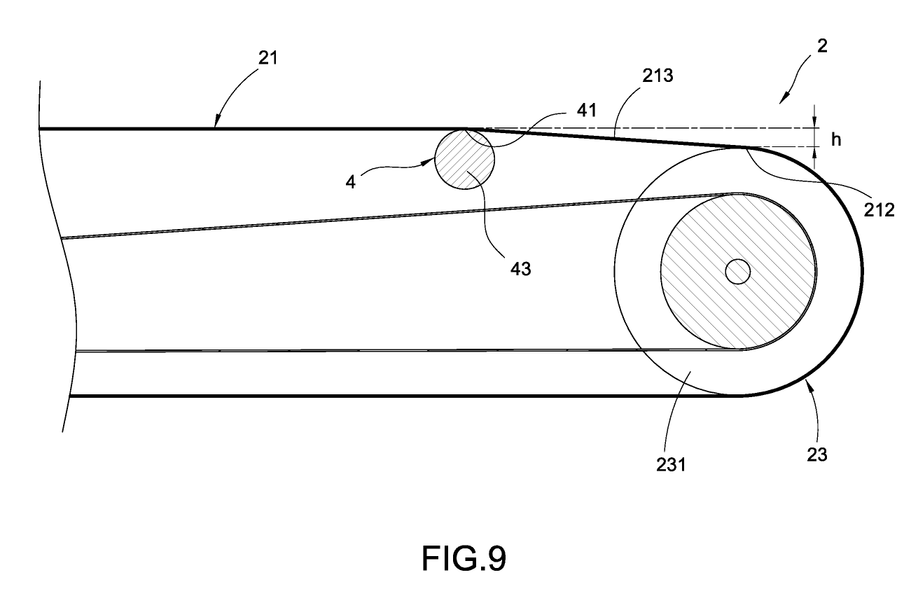

Please refer to FIGS. 8 and 9 for the second embodiment of the three-dimensional printing system 10. The second embodiment is similar to the first embodiment, except that the object detaching member 4 of the second embodiment has a different structure.

In detail, the object detaching member 4 is a rod 43, an axis of the rod 43 and an axis of the second roller 23 are parallel to each other, and the abutment portion 41 is formed at the top of the rod 43. By this configuration, the belt 21 is horizontal before the abutment portion 41, and is inclined after the abutment portion 41 (i.e. the inclined section 213) due to the height level difference h. This causes the object 100 to be gradually detached from the belt 21, thereby achieving the same effect as the first embodiment.

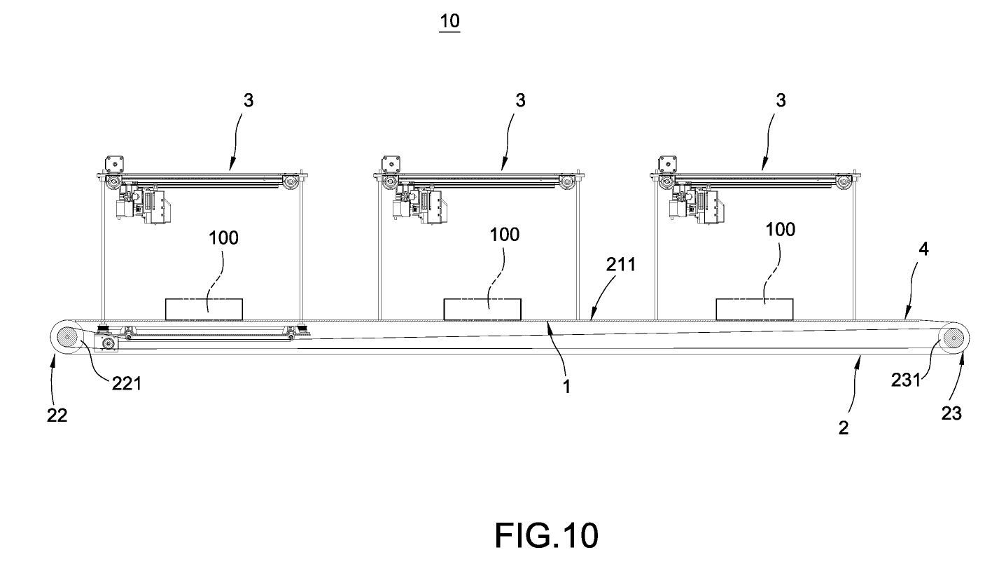

Please refer to FIG. 10 for the third embodiment of the three-dimensional printing system 10. The third embodiment is similar to the first embodiment, except that the third embodiment includes multiple printing devices 3.

Furthermore, according to a length of the printing area 211 of the delivery module 2, one or multiple printing devices 3 can be arranged, such that the multiple printing devices 3 can be arranged side by side along the support plate 1. The multiple printing devices 3 produce or color objects 100 individually. The printing devices 3 produce objects 100 respectively at the same time. After completion of printing, the objects 100 printed out are then sequentially sent to the material collecting track 5 (see FIG. 1), thereby achieving mass production and saving production time.

In summary, the three-dimensional printing system is neither disclosed by similar products nor used in public, and has industrial applicability, novelty and non-obviousness, so the present disclosure completely meets the requirements of patentability. Therefore, a request to patent the present disclosure is filed according to patent laws. Examination is kindly requested, and allowance of the present disclosure is solicited to protect the rights of the inventor.

What is claimed is:

1. A three-dimensional printing system, for printing out an object (100), the three-dimensional printing system (10) comprising:
a support plate (1);
a delivery module (2) including a belt (21) covering the support plate (1), the belt (21) including a printing area (211) above the support plate (1) and including a separation section (212) at one side of the support plate (1);
at least one printing device (3) disposed corresponding to the support plate (1), the object (100) being formed layer by layer in the printing area (211) via the printing device (3) and being moved with the belt (21); and
an object detaching member (4) disposed under the belt (21) and between the support plate (1) and the separation section (212), the object detaching member (4) including an abutment portion (41) abutted against the belt (21), the abutment portion (41) being at a position higher than a position of the separation section (212) to form a height level difference (h) between the abutment portion (41) and the separation section (212), so that the object (100) is detached from the belt (21) when the object (100) is moved to the separation section (212).

2. The three-dimensional printing system according to claim 1, wherein the belt (21) including an inclined section (213) between the abutment portion (41) and the separation section (212), and a height level of the inclined section (213) gradually decreases in a direction away from the abutment portion (41).

3. The three-dimensional printing system according to claim 1, wherein the object detaching member (4) is an extending plate (4) extended from one side of the support plate (1), and the abutment portion (41) is formed at one end of the extending plate (42) at one side adjacent to the separation section (212).

4. The three-dimensional printing system according to claim 3, wherein the delivery module (2) further includes a first roller (22) and a second roller (23), the first roller (22) and the second roller (23) are disposed at two sides of the support plate (1) to drive the belt (21) to move with respect to the support plate (1), and the separation section (212) is an area of the belt (21) in contact with the second roller (23).

5. The three-dimensional printing system according to claim 1, wherein the object detaching member (4) is a rod (43), and the abutment portion (41) is formed at the top of the rod (43).

6. The three-dimensional printing system according to claim 5, wherein the delivery module (2) further includes a first roller (22) and a second roller (23), the first roller (22) and the second roller (23) are disposed at two sides of the support plate (1) to drive the belt (21) to move with respect to the support plate (1), the separation section (212) is an area of the belt (21) in contact with the second roller (23), and an axis of the rod (43) and an axis of the second roller (23) are parallel to each other.

7. The three-dimensional printing system according to claim 1, wherein the support plate (1) includes an upper surface (11) in contact with the belt (21), and the upper surface (11) and the abutment portion (41) are on the same horizontal plane.

8. The three-dimensional printing system according to claim 1, wherein the three-dimensional printing system includes multiple printing devices (3), and the multiple printing devices (3) are arranged side by side along the support plate (1).

9. The three-dimensional printing system according to claim 1, further comprising a material collecting track (5), the material collecting track (5) being disposed corresponding to the separation section (212), the material collecting track (5) including an inclined surface (51) whose height level decreases in a direction away from the separation section (212).

10. The three-dimensional printing system according to claim 1, wherein the delivery module (2) further includes a first roller (22) and a second roller (23), the first roller (22) and the second roller (23) are disposed at two sides of the support plate (1) to drive the belt (21) to move with respect to the support plate (1), the separation section (212) is an area of the belt (21) in contact with the second roller (23), the first roller (22) is a drive wheel (221) actively driving the belt (21), and the second roller (23) is an idler (231) passively driving the belt (21).
